(19) United States
(12) Patent Application Publication
(10) Pub. No.: US 2012/0196624 A1
(43) Pub. Date: Aug. 2, 2012

(54) METHOD AND APPARATUS FOR REPORTING LOCATION OF MOBILE STATION IN WIRELESS COMMUNICATION SYSTEM

(75) Inventors: Shuang-Feng HAN, Suwon-si (KR); Sung-Eun PARK, Seoul (KR); Hyun-Kyu YU, Yongin-si (KR)

(73) Assignee: SAMSUNG ELECTRONICS CO. LTD., Suwon-si (KR)

(21) Appl. No.: 13/358,878

(22) Filed: Jan. 26, 2012

(30) Foreign Application Priority Data
Jan. 27, 2011 (KR) 10-2011-0008050

(51) Int. Cl. H04W 24/00; H04W 4/02

(52) U.S. Cl. 455/456.3; 455/456.5

(57) ABSTRACT

A method and an apparatus for reporting location information of a Mobile Station (MS) through a ranging procedure in a wireless communication system are provided. A Base Station (BS) transmits, to the MS, partition information representing a plurality of partition regions constituting the BS cell coverage. Upon receiving from the MS a ranging code belonging to one ranging code subset among a plurality of ranging code subsets corresponding to the plurality of partition regions based on the partition information, the BS determines location information of the MS depending on the partition region corresponding to the ranging code subset to which the received ranging code belongs, making it possible to notify the network of the MS's location information without the need to define a separate signaling procedure.

### PRIORITY

This application claims the benefit under 35 U.S.C. §119(a) of a Korean patent application filed in the Korean Intellectual Property Office on Jan. 27, 2011 and assigned Serial No. 10-2011-0008050, the entire disclosure of which is hereby incorporated by reference.

### BACKGROUND OF THE INVENTION

1. Field of the Invention

The present invention relates generally to a wireless communication system. More particularly, the present invention relates to a method and apparatus for efficiently reporting location information of a Mobile Station (MS) to a Base Station (BS) in a wireless communication system.

2. Description of the Related Art

In wireless communication systems, a Location-Based Service (LBS) for tracking geographical locations of MSs or users may be used for various purposes such as health check, business, and personal life management. The LBS may be generally classified into an MS-based technology and a network-based technology.

The typical MS-based technology includes a Global Positioning System (GPS) that uses satellites orbiting the earth. The GPS provides a fairly high accuracy, however, the GPS may have a low accuracy or may be inoperable in urban areas or in the indoor environment. The network-based technology is a technology for tracking locations of MSs based on the locations of BSs, Time Difference of Arrival (TDOA) between an MS and a BS, and Angle of Arrival (AOA) of signals, using a wireless communication network. In addition, various other location tracking technologies using Bluetooth, Ultra WideBand (UWB), Radio Frequency Identification (RFID), Wireless Fidelity (WiFi), etc. may be used.

Although the above-mentioned various technologies may acquire location information of users, each technology is available only when users have already entered the network. In addition, the location tracking should be linked to triggering and reporting procedures, and in most cases, location information may not be provided immediately.

Therefore, there is a need for more breakthrough technology for efficiently reporting locations of MSs to the BS during MS's network entry procedure.

### SUMMARY OF THE INVENTION

Aspects of the present invention are to address at least the above-mentioned problems and/or disadvantages and to provide at least the advantages described below. Accordingly, an aspect of an exemplary embodiment of the present invention is to provide a method and apparatus for reporting a geographical location of an MS in a downlink synchronization procedure.

Another aspect of an exemplary embodiment of the present invention is to provide a method and apparatus for reporting a location of an MS during a ranging procedure in a wireless communication system.

Further another aspect of an exemplary embodiment of the present invention is to provide a method and apparatus for dividing ranging codes based on the location of an MS in a wireless communication system.

Yet another aspect of an exemplary embodiment of the present invention is to provide a method and apparatus for allocating divided ranging codes to partition regions individually in a wireless communication system.

In accordance with an aspect of the present invention, a method for receiving a report on the location of a Mobile Station (MS) in a wireless communication system is provided. The method includes transmitting, to the MS, partition information representing a plurality of partition regions constituting a cell coverage of a Base Station (BS), receiving, from the MS, a code sequence belonging to one code subset among a plurality of code subsets corresponding to the plurality of partition regions, and determining location information of the MS according to the partition region corresponding to the code subset to which the received code sequence belongs.

In accordance with another aspect of the present invention, a method for transmitting a report on the location of a Mobile Station (MS) in a wireless communication system is provided. The method includes receiving, from a Base Station (BS), partition information representing a plurality of partition regions constituting a cell coverage of the BS, determining a code subset corresponding to a partition region to which the MS's current location belongs among a plurality of code subsets corresponding to the plurality of partition regions, based on the partition information; and transmitting a code sequence selected from the determined code subset to the BS.

In accordance with further another aspect of the present invention, a Base Station (BS) apparatus for receiving a report on the location of a Mobile Station (MS) in a wireless communication system is provided. The BS apparatus includes a transceiver for transmitting, to the MS, partition information representing a plurality of partition regions constituting a cell coverage of the BS, and for receiving, from the MS, a code sequence belonging to one code subset among a plurality of code subsets corresponding to the plurality of partition regions, and a controller for determining location information of the MS according to the partition region corresponding to the code subset to which the received code sequence belongs.

In accordance with yet another aspect of the present invention, a Mobile Station (MS) apparatus for transmitting a report on the location of the MS in a wireless communication system is provided. The MS apparatus includes a transceiver for receiving, from a Base Station (BS), partition information representing a plurality of partition regions constituting a cell coverage of the BS, and for transmitting a selected code sequence to the BS, and a controller for determining a code subset corresponding to a partition region to which the MS's current location belongs among a plurality of code subsets corresponding to the plurality of partition regions, based on the partition information, for selecting the code sequence from the determined code subset, and for transferring the selected code sequence to the transceiver.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 schematically illustrates a structure of a communication system according to an exemplary embodiment of the present invention;

FIG. 2 illustrates a message flow for a ranging procedure in a communication system according to an exemplary embodiment of the present invention;

FIGS. 3A to 3C illustrate examples of mapping cell partition regions to code sets according to an exemplary embodiment of the present invention;

FIG. 4A illustrates an example of a dedicated ranging channel for a Location-Based Service (LBS) according to an exemplary embodiment of the present invention;

FIG. 4B illustrates an example of grouping a ranging code set according to an exemplary embodiment of the present invention;

FIG. 5 illustrates an operation of partitioning cell coverage according to an exemplary embodiment of the present invention;

FIG. 6 illustrates an operation of a Base Station (BS) according to an exemplary embodiment of the present invention;

FIG. 7 illustrates an operation of a Mobile Station (MS) according to an exemplary embodiment of the present invention; and

FIG. 8 illustrates a schematic structure of a BS or an MS according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this specification, although reference will be made to the IEEE 802.16e/m-based communication standard in the description of location-based ranging operations in a wireless cellular communication system, it will be understood by those of ordinary skill in the art that the proposed ranging operations are not limited to a specific communication protocol or system structure, and that various changes in form and details may be made therein without departing from the spirit and scope of the invention as defined by the appended claims and their equivalents.

In a wireless communication system, particularly in a cellular communication system in which the entire service coverage is partitioned into a plurality of cells or cell coverages and each cell is managed by a Base Station (BS), a synchronization procedure between a Mobile Station (MS) and a BS is essential. After DownLink (DL) synchronization, an MS performs a procedure for ranging (or aligning) its transmission with the BS by acquiring an accurate timing offset and frequency offset of the BS and a power control value. This procedure is called a ranging procedure in an 802.16e/m-series communication system. Upon successful completion of the ranging procedure, the MS undergoes UpLink (UL) synchronization with the BS, and acquires a Temporary Station ID (TSTID) from the BS. The TSTID is used until the BS allocates a Station ID (STID) to the MS through a registration procedure.

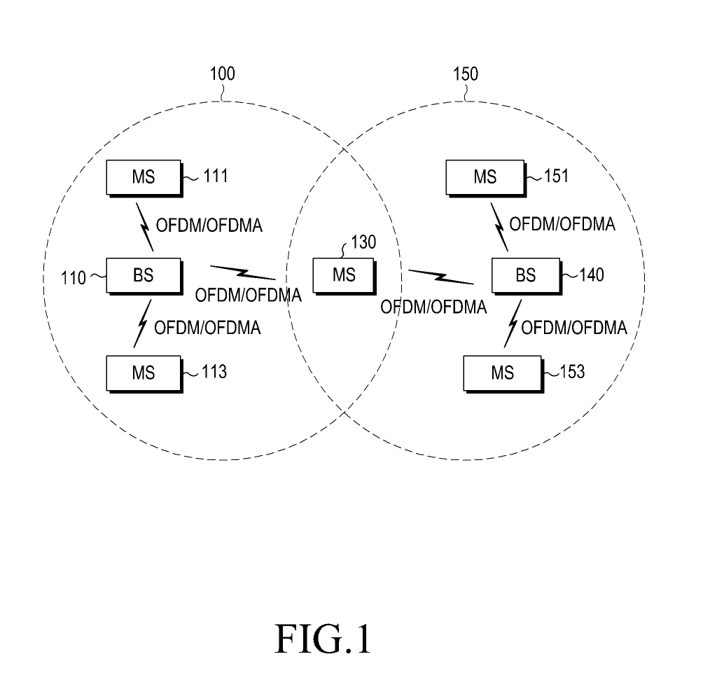

FIG. 1 schematically illustrates a structure of a communication system according to an exemplary embodiment of the present invention.

Referring to FIG. 1, the communication system with a multi-cell structure includes a cell #1 100 and a cell #2 150, and includes a BS #1 110 in charge of the cell #1 100, and a BS #2 140 in charge of the cell #2 150. The BSs 110 and 140 serve a plurality of MSs 111, 113, 130, 151 and 153 located in the cells 100 and 150. Signal exchange between the BSs 110 and 140 and the MSs 111, 113, 130, 151 and 153 may be achieved by Orthogonal Frequency Division Multiplexing (OFDM)/Orthogonal Frequency Division Multiple Access (OFDMA). Each of the MSs 111, 113, 130, 151 and 153 performs DL synchronization and ranging procedures based on the broadcast information that is periodically transmitted from each of the BSs 110 and 140, thereby completing a network entry procedure. Each of the MSs 111, 113, 130, 151 and 153 may be guaranteed the call continuity through handover even while the MSs are on the move between the cells 100 and 150.

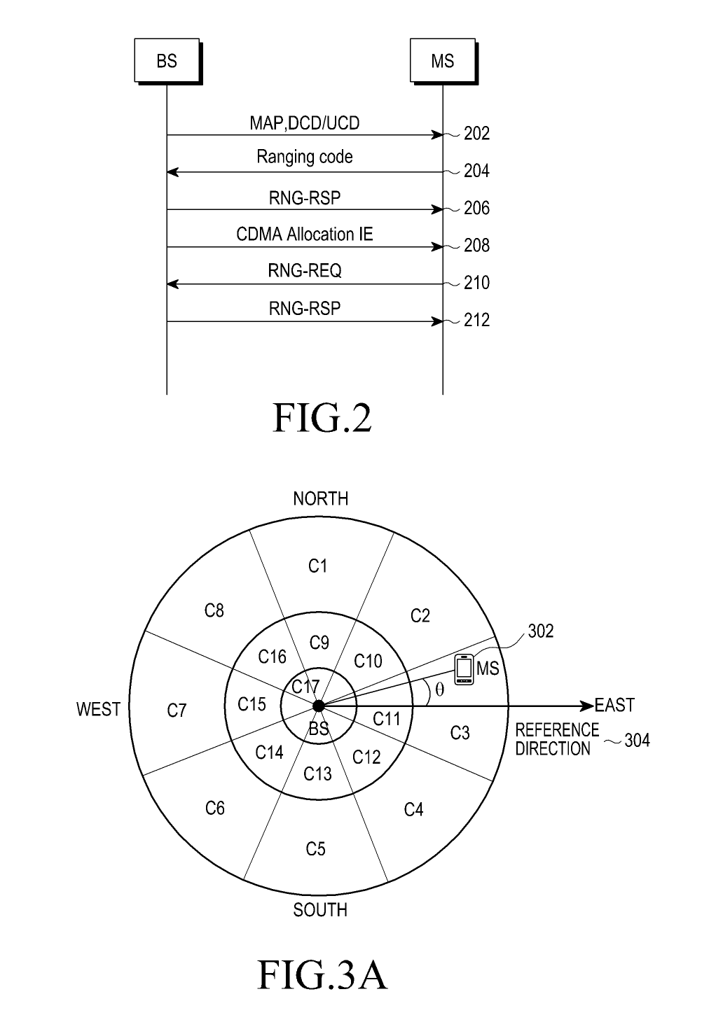

FIG. 2 illustrates a message flow for a ranging procedure in a communication system according to an exemplary embodiment of the present invention.

Referring to FIG. 2, after acquiring DL synchronization with a BS, an MS receives a MAP message and DL Channel Descriptor (DCD)/UL Channel Descriptor (UCD) containing DL/UL parameters, which are periodically transmitted from the BS, in step 202. The MAP message and the DCD/UCD include parameters related to the BS's DL and UL, and provide ranging information for supporting the MS's ranging. In step 204, the MS performs initial network entry by transmitting a ranging code randomly selected from a ranging code set included in the received information, to the BS.

In step 206, the BS may send a Ranging Response (RNG-RSP) message in response to the transmission by the MS of the ranging code to the BS. Upon determining that there is a need to correct MS's physical parameters in response to the ranging code, the BS sends to the MS a Code Division Multiple Access (CDMA) Allocation Information Element (IE) providing a UL bandwidth over which the MS will send a Ranging Request (RNG-REQ) message, in step 208. In step 210, the MS sends an RNG-REQ message including a ranging Connection ID (CID) having a required MS's Medium Access Control (MAC) address based on the CDMA Allocation IE. Although not illustrated, to request retransmission of the RNG-REQ message, the BS may resend the CDMA Allocation IE including the same ranging information.

In step 212, the BS notifies the MS of the successful reception of the RNG-REQ message by sending an RNG-RSP message to the MS. The RNG-RSP message includes information indicating the successful ranging status. By receiving the RNG-RSP message, the MS acquires an accurate timing offset and frequency offset, and a power control value. The MS ranges (or aligns) its transmission to the BS, completing the initial network entry procedure.

When the MS performs handover ranging to a target BS as the MS moves between cells, the MS may perform a handover ranging procedure using a handover ranging code instead of the initial ranging code set.

As described above, the MS performs the ranging procedure using one ranging code randomly selected from a ranging code set provided from the BS. A ranging channel and a ranging code for initial ranging may be defined, for example, by the standard, and each ranging channel designates a ranging opportunity.

In the below-described exemplary embodiment of the present invention, code sequences having a low correlation (e.g., ranging codes in a ranging code set) are mapped to a plurality of partition regions constructed by geographically partitioning the BS's cell coverage, thereby allowing the MS to efficiently perform location report during a ranging procedure. The cell coverage constituting the network may be partitioned uniformly or irregularly.

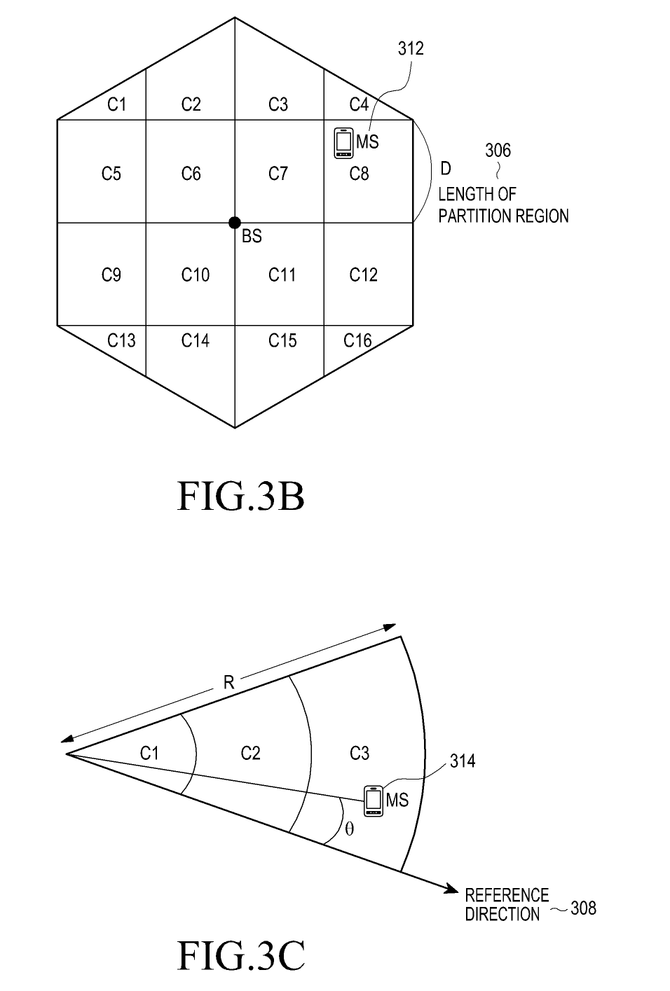

FIGS. 3A to 3C illustrate examples of mapping cell partition regions to code sets according to an exemplary embodiment of the present invention, in which examples of cell partitions having various different cell shapes are shown, however, the present invention may not be limited to these shapes and partitions. Cell coverage of each BS may be partitioned by one of various partition types according to the communication standard, the implementation, the system designer's choice, etc.

FIG. 3A shows circular partition, in which circle-shaped cell coverage is partitioned into a plurality of circular regions which are centered around the BS located at the center of the cell and have different radiuses from the center of the cell. Each circular region is partitioned into a plurality of sector-shaped partition regions having predetermined same or different angles. A subset including at least one ranging code is allocated to each partition region. As an example, the innermost circular region centered around the BS may be one partition region by itself without being further partitioned.

For example, a ranging code set available for initial ranging is grouped into 17 ranging code subsets C1-C17. As illustrated in FIG. 3A, the ranging code subsets C1-C8 are allocated to 8 partition regions in the outer circle, the ranging code subsets C9-C16 are allocated to 8 partition regions in the middle circle, and the ranging code subset C17 is allocated to the inner circle. If the partition type is determined to be a circular partition, then a mapping rule (i.e., a mapping order) of subsets for partition regions may be determined in advance between the BS and the MS. As another example, the MS may be notified of the mapping rule from the BS.

Each subset corresponding to each partition region may have the same or different number of ranging codes. In the cell coverage, a location of an MS 302 may be determined based on the distance from the BS and the angle with respect to a reference direction 304 (e.g., East)., For example, as illustrated in FIG. 3A, the MS 302 is located in the partition region to which the subset C3 is allocated.

The BS periodically or aperiodically broadcasts partition information such as partition type (i.e., circular partition), cell radius, partition angle (or the number of partition regions in each circular region), and the number of circular regions, along with its ranging code set and geographical location information (e.g., latitude and longitude). For example, example, according to the exemplary embodiment illustrated in FIG. 3A, the partition angle is 90°/8, and the number of circular regions is 3.

Based on the partition information and its location information, the MS determines a partition region to which it belongs, and performs a ranging procedure using a ranging code selected from a ranging code subset corresponding to the partition region to which the MS belongs. The BS may determine the approximate location of the MS based on the ranging code received from the MS.

FIG. 3B shows uniform partition, in which cell coverage of the BS may be partitioned into square-shaped partition regions having the same horizontal and/or vertical length regardless of the shape of the cell coverage. Similarly, a subset including at least one ranging code is allocated to each partition region. Partition regions located on the outskirts of the cell coverage may not have the exact square-shaped shape.

For example, a ranging code set available for initial ranging is grouped into 16 ranging code subsets C1˜C16. As illustrated in FIG. 3B, the subsets C1-C16 are allocated to 16 corresponding partition regions constituting the cell coverage of the BS. For example, the subsets may be allocated in the order of a partition region located in the northwest of the BS to a partition region located in the southeast. If the partition type is determined to be a uniform partition, a mapping rule (i.e., a mapping order) of subsets for partition regions may be determined in advance between the BS and the MS. As another example, the MS may be notified of the mapping rule from the BS. Each subset corresponding to each partition region may have the same or different number of ranging codes. For example, as illustrated in FIG. 3B, an MS 312 is located in the partition region to which the subset C8 is allocated.

The BS periodically or aperiodically broadcasts partition information such as partition type (i.e., uniform partition) and the size D 306 of each partition region, in addition to its corresponding ranging code set and geographical location information (e.g., latitude and longitude). Based on the partition information and its location information, the MS determines a partition region to which it belongs, and performs a ranging procedure using a ranging code selected from a ranging code subset for its partition region. The BS may determine the approximate location of the MS based on the ranging code received from the MS.

FIG. 3C shows beamforming partition, in which cell coverage is sectored and then partitioned into a plurality of sector-shaped partition regions having different radiuses according to the distance from the BS located at the vertex of the sector, and a subset including at least one ranging code is allocated to each partition region.

For example, a ranging code set available for initial ranging is grouped into 3 ranging code subsets C1-C3. The ranging code subsets C1-C3 are allocated to an inner partition region, a middle partition region, and an outer partition region, respectively. If the partition type is determined to be a beamforming partition, then a mapping rule (i.e., a mapping order) of subsets for partition regions may be determined in advance between the BS and the MS. As another example, the MS may be notified of the mapping rule from the BS. Each subset corresponding to each partition region may have the same or different number of ranging codes. In the cell coverage, a location of an MS 314 may be determined based on the distance from the BS and the angle with respect to a reference direction 308. For example, as illustrated in FIG. 3C, the MS 314 is located in the partition region to which the subset C3 is allocated.

The BS periodically or aperiodically broadcasts partition information such as partition type (i.e., beamforming partition), cell radius, the number of partition regions, and reference direction 308, along with its ranging code set and geographical location information (e.g., latitude and longitude). In the shown example, the cell radius is R and the number of partition regions is 3. Based on the partition information and its location information, the MS determines a partition region to which it belongs, and performs a ranging procedure using a ranging code selected from a ranging code subset for its partition region. The BS may determine the approximate location of the MS based on the ranging code received from the MS.

The MS's location determined through the above procedure is reported to a Location-Based Service (LBS) server by the BS or from the BS. The MS's location may be used for various purposes such as, for example, a health check, an amenity search, friend find, or the like. In the actual communication environment, in most cases, only the approximate and useful MS's location is needed rather than the exact MS's location. Accordingly, the BS or the LBS server may provide an appropriate LBS service desired by the user which merely corresponds to the partition region to which the MS belongs.

Although it has been assumed herein that the BS broadcasts partition information related to partitioning of cell coverage, each BS's partition type (e.g., circular partition, uniform partition and beamforming partition) may be mapped to different subframes constituting each frame in a time domain in an alternative exemplary embodiment. For example, in one frame, a subframe #i represents an i-th partition type.

In another optional alternative exemplary embodiment, the BS may allocate to the MS a dedicated ranging channel for LBS independently of a ranging channel for normal ranging. The term ‘normal ranging’ as used herein may refer to initial ranging and handover ranging defined in a communication system. In other words, the MS reports its location information to the BS by transmitting a ranging code corresponding to its partition region through a dedicated ranging channel allocated for LBS. Upon receiving the ranging code through the dedicated ranging channel for LBS, the BS may provide an appropriate LBS based on the MS's location information instead of performing a ranging procedure.

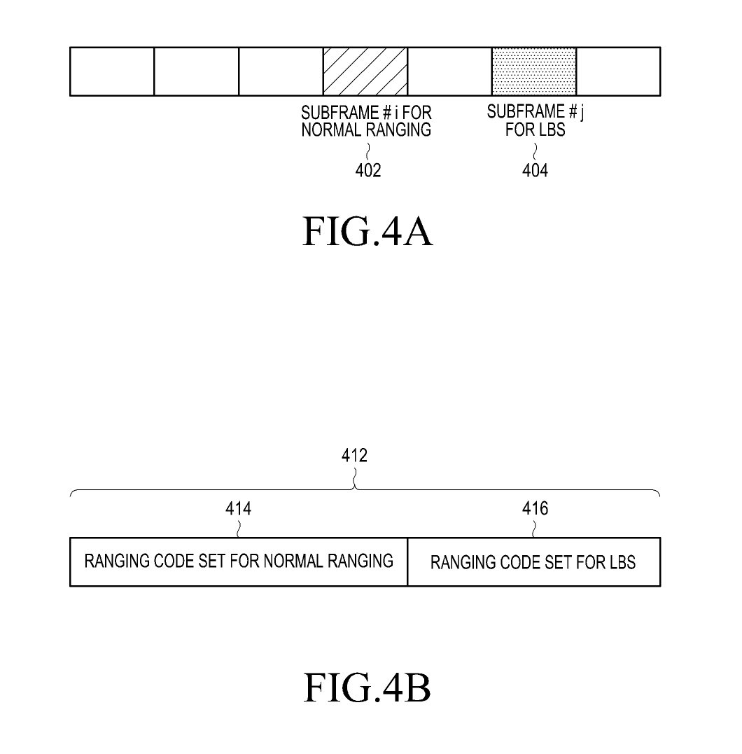

FIG. 4A illustrates an example of a dedicated ranging channel for LBS according to an exemplary embodiment of the present invention. Although it is assumed herein that the dedicated ranging channel for LBS is allocated to a specific subframe in the time domain, the dedicated ranging channel for LBS may be allocated to a specific resource region in the frequency domain (not in the time domain), or in the time-frequency domain.

Referring to FIG. 4A, at least one subframe #i 402 among a plurality of subframes constituting one frame in the time domain is allocated for normal ranging, and the MS uses the subframe #i 402 during transmission of a ranging code for normal ranging. At last one subframe #j 404 is allocated to a dedicated ranging channel for LBS, and to support or request LBS, the MS transmits a ranging code corresponding to its allocation region through the subframe #j 404.

In another exemplary embodiment, the BS's ranging code set is grouped into a first ranging code set for normal ranging and a second ranging code set for LBS. The BS performs a ranging procedure or determines location information of the MS depending on the ranging code set to which the ranging code received from the MS belongs.

FIG. 4B illustrates an example of grouping a ranging code set according to an exemplary embodiment of the present invention.

Referring to FIG. 4B, a ranging code set 412 that the BS can use is grouped into a first ranging code set 414 for normal ranging, and a second ranging code set 416 for LBS. Each of the ranging code sets 414 and 416 includes a plurality of ranging codes. The MS may transmit one ranging code selected from the first ranging code set 414 to perform initial ranging or handover ranging, and the BS performs a ranging procedure by receiving the ranging code. The MS may transmit to the BS a ranging code in a ranging code subset corresponding to its partition region among the ranging codes in the second ranging code set 416 for LBS, and the BS determines the MS's location information by receiving the ranging code.

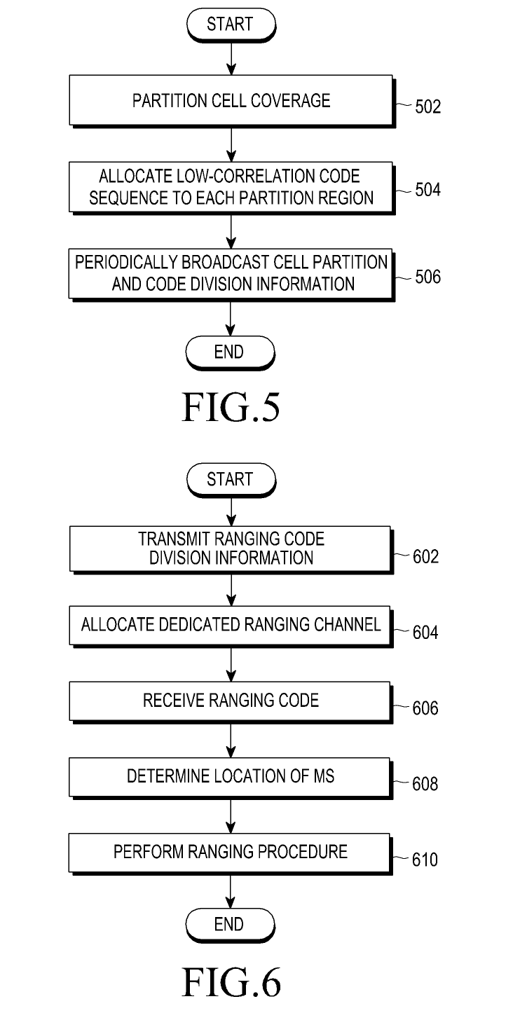

FIG. 5 illustrates an operation of partitioning cell coverage according to an exemplary embodiment of the present invention. Each BS's cell coverage may be partitioned by each BS individually, may be partitioned by an upper-layer system, or may be determined in advance by the communication standard or the system designer. It is assumed herein that each BS partitions its cell coverage in the operation performed by the BS.

Referring to FIG. 5, in step 502, the BS partitions its cell coverage into a plurality of partition regions according to the predetermined number of partition regions and/or the predetermined partition type. In step 504, the BS maps one or more code sequences predetermined to have a low correlation, to the plurality of partition regions. As a specific example, ranging code subsets each including one or more ranging codes are allocated to the partition regions. The ranging code subsets are divided from a ranging code set available by the BS for a ranging procedure, from a ranging code set available for LBS, or from both ranging code sets.

In step 506, the BS periodically broadcasts cell partition and code division information corresponding to the partition and mapping results to MSs in the cell. The cell partition and code division information may be transmitted, for example, in a MAP message, UCD/DCD, or a separate broadcast message. In an alternative exemplary embodiment, the cell partition and code division information may be aperiodically transmitted at the time that is agreed upon between the BS and the MS, or recognizable by the MS.

If a circular partition is used, then the cell partition and code division information includes at least one of partition type, cell radius, partition angle (or the number of partitions in each circular region), and the number of circular regions. If a uniform partition is used, then the cell partition and code division information includes at least one of partition type and the size of each partition region. If a beamforming partition is used, then the cell partition and code division information includes at least one of partition type, cell radius, the number of partition regions, and reference direction. In addition, the cell partition and code division information may further include at least one of information about how the BS's ranging code set is divided, location information of the BS, information about the cell shape and/or radius, and information about which ranging code subset is mapped to each partition region.

FIG. 6 illustrates an operation of a BS according to an exemplary embodiment of the present invention.

Referring to FIG. 6, in step 602, the BS periodically or aperiodically transmits cell partition and code division information including at least one of cell partition-related information and ranging code division-related information, to MSs located in its cell. As an example, if the cell partition and code division information has already been transmitted by the cell partitioning operation as shown in FIG. 5, step 602 is optional. In step 604, the BS allocates a dedicated ranging channel for a ranging procedure or LBS to at least one of the MSs. As another example, if the dedicated ranging channel is designated in advance by a communication standard or a system designer, step 604 is optional.

In step 606, the BS receives a ranging code from at least one of the MSs in its cell through the dedicated ranging channel. In step 608, the BS determines location information of the MS based on the type of the dedicated ranging channel and the ranging code subset to which the ranging code belongs. Specifically, the BS determines that the BS already knows ranging code subsets divided from an available ranging code set and partition regions corresponding to the ranging code subsets, and the MS is located in a partition region corresponding to the ranging code subset to which the received ranging code belongs, among the ranging code subsets.

In step 610, the BS performs the remaining ranging procedure based on the ranging code. An example of the remaining ranging procedure includes steps 206 to 212 shown in FIG. 2 in the case of initial ranging. If the ranging code was transmitted only for LBS (not for normal ranging), step 610 is optional. Although not illustrated, the BS may directly provide LBS for the MS based on the determined MS's location information, or may deliver the determined MS's location information to a separate LBS server to support LBS provision for the MS.

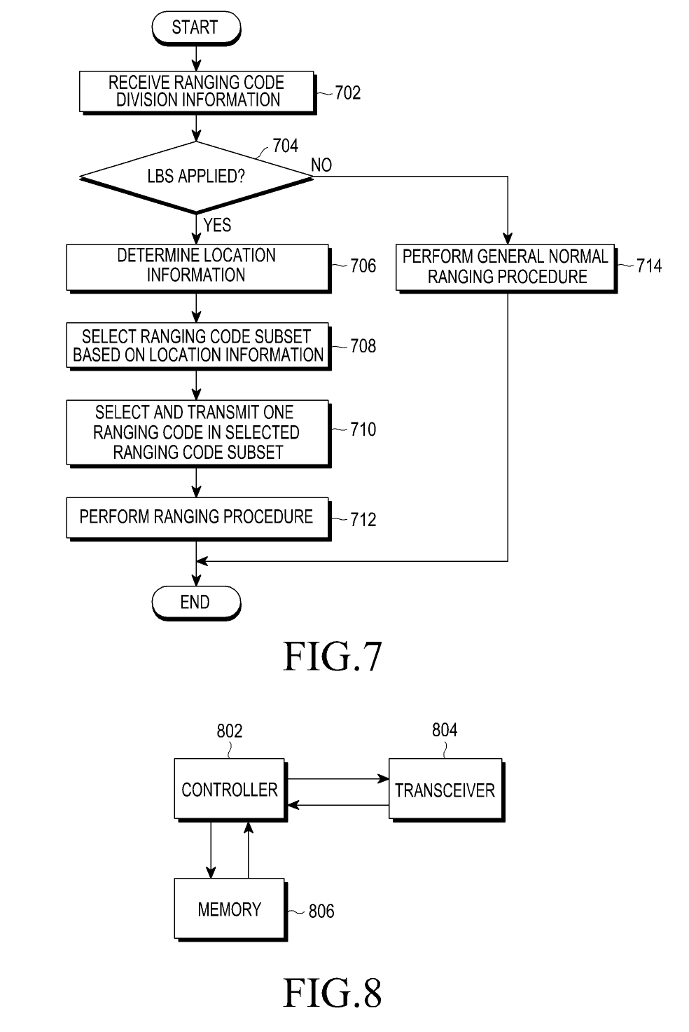

FIG. 7 illustrates an operation of an MS according to an exemplary embodiment of the present invention.

Referring to FIG. 7, in step 702, the MS receives cell partition and code division information from the BS managing the cell coverage where the MS is located, and the MS determines the partition type of the cell coverage according to the partition information. Specifically, the MS determines partition regions constituting the cell coverage. In step 704, the MS determines whether to run LBS depending on the predetermined settings such as user settings or hardware settings. If the MS is set not to run LBS, the MS performs a general normal ranging procedure at a desired time in step 714. On the other hand, if the MS is set to run LBS, the MS proceeds to step 706.

In step 706, the MS determines its location information (e.g., latitude and longitude) according to the MS-based location tracking technology such as GPS, WLAN, Bluetooth, and RFID. In an alternative exemplary embodiment, the MS may acquire its location information using the external means such as GPS input and user input. In step 708, the MS determines its partition region corresponding to the location information based on the partition information, and selects one ranging code subset mapped to the partition region among a plurality of ranging code subsets divided from the ranging code set available by the BS.

In step 710, the MS selects one ranging code from among at least one ranging code belonging to the selected ranging code subset at the time when the ranging procedure is required, or at the time when the MS is determined to transmit its location information for LBS, and transmits the selected ranging code to the BS. The ranging code is transmitted through a dedicated ranging channel allocated by the BS for normal ranging or LBS. In step 712, the MS performs the remaining ranging procedure based on the ranging code. For example, the remaining ranging procedure may include steps 206 to 212 shown in FIG. 2 in the case of initial ranging. If the ranging code was transmitted only for LBS (not for normal ranging), step 712 may be optional.

The above-described exemplary embodiments may be implemented in the form of program commands that can be executed by various computer means, and then recorded in a computer-readable recording medium. The computer-readable recording medium may include program commands, data files, data structures, etc. independently or in combination. Although the program commands recorded in the computer-readable recording medium may be designed and configured specially for the present invention, the program commands known to those in the field of computer software may also be used.

The above-described exemplary embodiments may also be realized by mounting a memory device having stored program codes for implementing the operations, in the BS and the MS. In other words, the BS and the MS perform the above-described operations by reading and running the program codes stored in the memory device by means of a processor or a Central Processing Unit (CPU). Specifically, both or at least one of the BS and MS are configured to implement the operation corresponding to at least one of the above-described embodiments.

FIG. 8 illustrates a schematic structure of a BS or an MS according to an exemplary embodiment of the present invention. Although not illustrated, the MS may further include a location determining unit for determining its location information, such as GPS or the like.

When the structure serves as a BS, a controller 802 generates partition information representing partitioning of the BS's cell coverage and division of the BS's ranging code set based on cell shape information, partition type information, and a ranging code set stored in a memory 806, and broadcasts the generated partition information to MSs in its cell through a transceiver 804. Upon receiving a ranging code from an MS in the cell through the transceiver 804, the controller 802 determines a partition region where the MS is located, based on the mapping information between partition regions and ranging code subsets stored in the memory 805, and performs a ranging procedure or an LBS operation if necessary.

When the structure serves as an MS, the controller 802 receives partition information representing partitioning of the cell coverage where the MS is located and division of a ranging code set, from the BS through the transceiver 804, and stores the received partition information in the memory 806 in an appropriate format. Upon a request for transmitting a ranging code for a ranging procedure or LBS, the controller 802 selects one ranging code from a ranging code subset corresponding to its current location information among the BS's ranging code subsets that the MS has received and stored in the memory 806 in advance, and then transmits the selected ranging code to the BS through the transceiver 804. Thereafter, the controller 802 may perform the ranging procedure if necessary.

As is apparent from the foregoing description, the proposed method and apparatus may report the approximate location information of the MS to the network during the existing code sequence transmission procedure or ranging procedure without the need to define a separate signaling procedure for reporting location information to the network for the MS employing MS-based location tracking technology such as GPS, thereby reducing handover for MS's location report and thus improving the network performance.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for receiving a location report of a Mobile Station (MS) in a wireless communication system, the method comprising:
transmitting, to the MS, partition information representing a plurality of partition regions constituting a cell coverage of a Base Station (BS);
receiving, from the MS, a code sequence belonging to one code subset among a plurality of code subsets corresponding to the plurality of partition regions; and
determining location information of the MS according to the partition region corresponding to the code subset to which the received code sequence belongs.

2. The method of claim 1, wherein each of the plurality of code subsets includes one or more ranging codes used for a ranging procedure.

3. The method of claim 1, further comprising:
partitioning the cell coverage into a plurality of circular regions which are centered around the BS located at the center of the cell coverage and which have different radiuses;
partitioning the circular regions into a plurality of sector-shaped partition regions each having a predetermined partition angle; and
mapping a plurality of ranging code subsets each including at least one ranging code to the sector-shaped partition regions.

4. The method of claim 3, wherein the partition information includes at least one of geographical location information of the BS, a partition type of the cell coverage, a cell radius of the cell coverage, a partition angle, a number of sector-shaped partition regions in each circular region, and a number of circular regions.

5. The method of claim 1, further comprising:
partitioning the cell coverage into a plurality of square-shaped partition regions having the same horizontal and/or vertical length; and
mapping a plurality of ranging code subsets each including at least one ranging code to the square-shaped partition regions.

6. The method of claim 5, wherein the partition information includes at least one of geographical location information of the BS, a partition type of the cell coverage, and a size of each square-shaped partition region.

7. The method of claim 1, further comprising:
sectoring the cell coverage, and partitioning the cell coverage into a plurality of sector-shaped partition regions according to the distance from the BS; and
mapping a plurality of ranging code subsets each including at least one ranging code to the sector-shaped partition regions.

8. The method of claim 7, wherein the partition information includes at least one of geographical location information of the BS, a partition type of the cell coverage, a cell radius of the cell coverage, the number of partition regions, and a reference direction.

9. The method of claim 1, wherein the code sequence is received through at least one subframe allocated for normal ranging, or through at least one subframe allocated for a Location-Based Service (LBS).

10. The method of claim 1, wherein a code set including code sequences available by the BS includes a first code set for normal ranging and a second code set for LBS, and the code subsets are included in the second code set.

11. A method for transmitting a location report of a Mobile Station (MS) in a wireless communication system, comprising:
receiving, from a Base Station (BS), partition information representing a plurality of partition regions constituting a cell coverage of the BS;
determining a code subset corresponding to a partition region to which the MS's current location belongs among a plurality of code subsets corresponding to the plurality of partition regions, based on the partition information; and
transmitting a code sequence selected from the determined code subset to the BS.

12. The method of claim 11, wherein each of the plurality of code subsets includes one or more ranging codes used for a ranging procedure.

13. The method of claim 11, further comprising:
partitioning the cell coverage into a plurality of circular regions which are centered around the BS located at the center of the cell coverage and which have different radiuses;
partitioning the circular regions into a plurality of sector-shaped partition regions each having a predetermined partition angle; and
mapping a plurality of ranging code subsets each including at least one ranging code to the sector-shaped partition regions.

14. The method of claim 13, wherein the partition information includes at least one of geographical location information of the BS, a partition type of the cell coverage, a cell radius of the cell coverage, a partition angle, a number of sector-shaped partition regions in each circular region, and a number of circular regions.

15. The method of claim 11, further comprising:
partitioning the cell coverage into a plurality of square-shaped partition regions having the same horizontal and/or vertical length; and
mapping a plurality of ranging code subsets each including at least one ranging code to the square-shaped partition regions.

16. The method of claim 15, wherein the partition information includes at least one of geographical location information of the BS, a partition type of the cell coverage, and a size of each square-shaped partition region.

17. The method of claim 11, further comprising:
sectoring the cell coverage, and partitioning the cell coverage into a plurality of sector-shaped partition regions according to the distance from the BS; and
mapping a plurality of ranging code subsets each including at least one ranging code to the sector-shaped partition regions.

18. The method of claim 17, wherein the partition information includes at least one of geographical location information of the BS, a partition type of the cell coverage, a cell radius of the cell coverage, a number of partition regions, and a reference direction.

19. The method of claim 11, wherein the code sequence is transmitted through at least one subframe allocated for normal ranging, or through at least one subframe allocated for a Location-Based Service (LBS).

20. The method of claim 11, wherein a code set including code sequences available by the BS includes a first code set for normal ranging and a second code set for LBS, and the code subsets are included in the second code set.

21. A Base Station (BS) apparatus for receiving a location report of a Mobile Station (MS) in a wireless communication system, the BS apparatus comprising:
a transceiver for transmitting, to the MS, partition information representing a plurality of partition regions constituting a cell coverage of the BS, and receiving, from the MS, a code sequence belonging to one code subset among a plurality of code subsets corresponding to the plurality of partition regions; and
a controller for determining location information of the MS according to the partition region corresponding to the code subset to which the received code sequence belongs.

22. The BS apparatus of claim 21, wherein each of the plurality of code subsets includes one or more ranging codes used for a ranging procedure.

23. The BS apparatus of claim 21, wherein the controller is configured for:
partitioning the cell coverage into a plurality of circular regions which are centered around the BS located at the center of the cell coverage and which have different radiuses;
partitioning the circular regions into a plurality of sector-shaped partition regions each having a predetermined partition angle; and
mapping a plurality of ranging code subsets each including at least one ranging code to the sector-shaped partition regions.

24. The BS apparatus of claim 23, wherein the partition information includes at least one of geographical location information of the BS, a partition type of the cell coverage, a cell radius of the cell coverage, a partition angle, a number of sector-shaped partition regions in each circular region, and a number of circular regions.

25. The BS apparatus of claim 21, wherein the controller is configured for:
partitioning the cell coverage into a plurality of square-shaped partition regions having the same horizontal and/or vertical length; and
mapping a plurality of ranging code subsets each including at least one ranging code to the square-shaped partition regions.

26. The BS apparatus of claim 25, wherein the partition information includes at least one of geographical location information of the BS, a partition type of the cell coverage, and a size of each square-shaped partition region.

27. The BS apparatus of claim 21, wherein the controller is configured for:
sectoring the cell coverage, and partitioning the cell coverage into a plurality of sector-shaped partition regions according to the distance from the BS; and
mapping a plurality of ranging code subsets each including at least one ranging code to the sector-shaped partition regions.

28. The BS apparatus of claim 27, wherein the partition information includes at least one of geographical location information of the BS, a partition type of the cell coverage, a cell radius of the cell coverage, a number of partition regions, and a reference direction.

29. The BS apparatus of claim 21, wherein the code sequence is received through at least one subframe allocated for normal ranging, or through at least one subframe allocated for a Location-Based Service (LBS).

30. The BS apparatus of claim 21, wherein a code set including code sequences available by the BS includes a first code set for normal ranging and a second code set for LBS, and the code subsets are included in the second code set.

31. A Mobile Station (MS) apparatus for transmitting a location report of a MS in a wireless communication system, the MS apparatus comprising:
a transceiver for receiving, from a Base Station (BS), partition information representing a plurality of partition regions constituting a cell coverage of the BS, and for transmitting a selected code sequence to the BS; and
a controller for determining a code subset corresponding to a partition region to which the MS's current location belongs among a plurality of code subsets corresponding to the plurality of partition regions, based on the partition information, for selecting the code sequence from the determined code subset, and for transferring the selected code sequence to the transceiver.

32. The MS apparatus of claim 31, wherein each of the plurality of code subsets includes one or more ranging codes used for a ranging procedure.

33. The MS apparatus of claim 31, wherein the cell coverage is partitioned into a plurality of circular regions which are centered around the BS located at the center of the cell coverage and which have different radiuses, and the circular regions are partitioned into a plurality of sector-shaped partition regions having a predetermined partition angle; and
wherein a plurality of ranging code subsets each including at least one ranging code are mapped to the sector-shaped partition regions.

34. The MS apparatus of claim 33, wherein the partition information includes at least one of geographical location information of the BS, a partition type of the cell coverage, a cell radius of the cell coverage, a partition angle, a number of sector-shaped partition regions in each circular region, and a number of circular regions.

35. The MS apparatus of claim 31, wherein the cell coverage is partitioned into a plurality of square-shaped partition regions having the same horizontal and/or vertical length; and
wherein a plurality of ranging code subsets each including at least one ranging code are mapped to the square-shaped partition regions.

36. The MS apparatus of claim 35, wherein the partition information includes at least one of geographical location information of the BS, a partition type of the cell coverage, and a size of each square-shaped partition region.

37. The MS apparatus of claim 31, wherein the cell coverage is sectored, and partitioned into a plurality of sector-shaped partition regions according to the distance from the BS; and
wherein a plurality of ranging code subsets each including at least one ranging code are mapped to the sector-shaped partition regions.

38. The MS apparatus of claim 37, wherein the partition information includes at least one of geographical location information of the BS, a partition type of the cell coverage, a cell radius of the cell coverage, a number of partition regions, and a reference direction.

39. The MS apparatus of claim 31, wherein the code sequence is transmitted through at least one subframe allocated for normal ranging, or through at least one subframe allocated for a Location-Based Service (LBS).

40. The MS apparatus of claim 31, wherein a code set including code sequences available by the BS includes a first code set for normal ranging and a second code set for LBS, and the code subsets are included in the second code set.
